(19) United States
(12) Patent Application Publication
(10) Pub. No.: US 2025/0194890 A1
(43) Pub. Date: Jun. 19, 2025

(54) ROBOT CLEANER AND ROBOT SYSTEM COMPRISING SAME

(71) Applicant: LG ELECTRONICS INC., Seoul (KR)

(72) Inventors: Byoungsuk CHOI, Seoul (KR); Seungjin AHN, Seoul (KR)

(73) Assignee: LG ELECTRONICS INC., Seoul (KR)

(21) Appl. No.: 18/721,101

(22) PCT Filed: Nov. 4, 2022
(86) PCT No.: PCT/KR2022/017284

§ 371 Date: Mar. 6, 2025

(30) Foreign Application Priority Data
Dec. 17, 2021 (KR) 10-2021-0182050

(51) Int. Cl. A47L 11/40; A47L 11/282; G05D 1/648; G05D 105/10

(52) U.S. Cl. CPC A47L 11/4066; A47L 11/282; A47L 11/4011; A47L 11/4038; A47L 11/4061; G05D 1/648; A47L 2201/04; G05D 2105/10

(57) ABSTRACT

A robot cleaner according to one embodiment of the present invention comprises: a main body for forming the exterior thereof; a pair of rotary mops to which cleaning cloths are attached, and which come in contact with the floor and moves, while rotating, the main body in a zigzag pattern including first traveling, in which the main body travels straight in a first direction, and second traveling, in which the main body travels straight in a second direction that is opposite the first direction; and a control unit for setting the zigzag pattern by varying the distance between a travel axis along which the main body travels during the first traveling and a travel axis during the second traveling according to the amount that the current position of the main body deviates from the travel axis. Therefore, while the mop robot cleaner travels in a zigzag, the line gap thereof is changed according to deviation information so that cleaning time satisfying a minimum overlapping region can be minimized.

### TECHNICAL FIELD

The present disclosure relates to a method for controlling a robot cleaner, and more specifically, to a method for controlling a robot cleaner that uses a rotary mop.

### BACKGROUND ART

Recently, robots are increasingly used at home. Atypical example of such robots for home use is a cleaning robot. Cleaning robots are mobile robots that autonomously travel a given area to automatically clean a space by sucking dirt such as dust accumulated on a floor or by sweeping the floor with a rotary mop while moving using the rotary mop. Also, the floor can be cleaned by supplying water to the rotary mop and wet-mopping the floor.

The thing to note here is that mop robot cleaners wet-mop a floor while traveling in a zigzag pattern. Korean Laid-Open Patent No. 10-2017-0099752 discloses a mop robot cleaner in which a path is set to allow some spaces to overlap each other when it travels in a zigzag line.

Mop robot cleaners are configured to allow some parts of the zigzag line to overlap each other, because there is some uncleaned area of a certain width at the center of rotation of the robot when the robot travels in a mop-spinning manner. However, this conventional technology offers no specific method for determining which parts of the zigzag overlap. Thus, if the robot cleaner deviates sharply from its straight line during zigzag travel, some areas may be left uncleaned even if the robot travels in an overlapping fashion.

Moreover, in order to prevent this, a fairly large amount of overlap is required for zigzag t, which involves unnecessary travel and cleaning in overlapping regions, thus lengthening the cleaning time.

Meanwhile, U.S. Unexamined Patent Application No. 2020-0345193 discloses determining the amount of overlap for zigzag cleaning corresponding to a cleaning level selected by a user, in the traveling of a mop cleaner cleans.

That is, it discloses application of zigzag travel using a pre-defined amount of overlap corresponding to a level selected by the user.

However, one issue with this prior art document is that the cleaning effect that customers would expect may not be achieved depending on the environment of the floor to be cleaned or when there are variations in the performance of the robot cleaner, since a pre-defined amount of overlap is used.

### PRIOR ART DOCUMENTS

### Patent Documents

Korean Laid-Open Patent No. 10-2019-0015929 (2019.02.15)
U.S. Unexamined Patent Application No. 2020-0345193 (2020.11.05)

### DETAILED DESCRIPTION OF INVENTION

### Technical Problems

An aspect of the present disclosure is to provide control of a robot cleaner which, while a mop robot cleaner travels in a zigzag, optimally changes the line gap thereof according to deviation information so that a minimum overlapping region is satisfied.

Another aspect of the present disclosure is to provide an adaptive zigzag-traveling robot cleaner which can periodically sense the distance and direction of deviation of the robot cleaner from its path and change settings for a zigzag line gap according to a sensed value.

The aspects of the present disclosure are not limited to the foregoing, and other aspects not mentioned herein will be clearly understood by those skilled in the art from the following description.

### Technical Solution

An exemplary embodiment of the present disclosure provides a robot cleaner including: a main body for forming the exterior thereof; a pair of rotary mops to which cleaning cloths are attached, and which come in contact with the floor and moves, while rotating, the main body in a zigzag pattern including first traveling, in which the main body travels straight in a first direction, and second traveling, in which the main body travels straight in a second direction that is opposite the first direction; and a control unit for setting the zigzag pattern by varying the distance between a travel axis along which the main body travels during the first traveling and a travel axis during the second traveling according to the amount that the current position of the main body deviates from the travel axis.

The robot cleaner may further include a sensor unit for periodically calculating the current position.

The controller may calculate the distance and direction of deviation of the current position from the travel axis along which the main body travels.

If the deviation direction is a positive direction, the controller may correct the distance according to the deviation distance and resets the next travel axis so as to have a corrected distance.

The controller may set the corrected distance for the next travel axis according to the maximum value of the distance of deviation during a straight travel on one of the travel axes.

The controller may maintain the distance if the deviation direction has a negative value.

The controller may perform control such that the first traveling and the second traveling are sequentially and repeatedly performed.

The controller may set the distance between the first traveling and the second traveling in such a way that the movement trajectories of the rotary mops have a predetermined overlapping region.

The controller may set the corrected distance in such a way that the difference between the width of the main body and the width of the overlapping region corresponds to a difference in the maximum value of the distance of deviation.

If the maximum value of the distance of deviation is smaller than the width of the overlapping region, the controller may maintain the distance.

Another exemplary embodiment of the present disclosure provides a robot cleaner system including: a robot cleaner for performing wet cleaning in a cleaning area; a server that sends and receives information to and from the robot cleaner and performs control of the robot cleaner; and a user terminal that is paired with the robot cleaner and the server and performs control of the robot cleaner as an application for controlling the robot cleaner is enabled, the robot cleaner including: a main body for forming the exterior thereof; a pair of rotary mops to which cleaning cloths are attached, and which come in contact with the floor and moves, while rotating, the main body in a zigzag pattern including first traveling, in which the main body travels straight in a first direction, and second traveling, in which the main body travels straight in a second direction that is opposite the first direction; and a control unit for setting the zigzag pattern by varying the distance between a travel axis along which the main body travels during the first traveling and a travel axis during the second traveling according to the amount that the current position of the main body deviates from the travel axis.

The user terminal may transmit a command value for a plurality of cleaning modes to the robot cleaner, and the controller sets a zigzag pattern by a distance that is set according to the command value.

The controller may calculate the distance and direction of deviation of the current position from the travel axis along which the main body travels.

If the deviation direction is a positive direction, the controller may correct the distance according to the deviation distance and reset the next travel axis so as to have a corrected distance.

The controller may set the corrected distance for the next travel axis according to the maximum value of the distance of deviation during a straight travel on one of the travel axes.

The controller may maintain the distance if the deviation direction has a negative value.

The controller may perform control such that the first traveling and the second traveling are sequentially and repeatedly performed.

The controller may set the distance between the first traveling and the second traveling in such a way that the movement trajectories of the rotary mops have a predetermined overlapping region.

The controller may set the corrected distance in such a way that the difference between the width of the main body and the width of the overlapping region corresponds to a difference in the maximum value of the distance of deviation.

If the maximum value of the distance of deviation is smaller than the width of the overlapping region, the controller may maintain the distance.

### Effect of Invention

The robot cleaner of the present disclosure has one or more of the following effects.

According to the present disclosure, while the mop robot cleaner travels in a zigzag, the line gap thereof is changed according to deviation information so that cleaning time satisfying a minimum overlapping region can be minimized

Moreover, it is possible provide an adaptive zigzag-traveling robot cleaner which can periodically sense the distance and direction of deviation of the robot cleaner from its path and therefore change settings for a zigzag line gap according to a sensed value.

In addition, it is possible to perform control in such a way as to prevent the occurrence of an uncleaned area by changing the distance to the next zigzag line, even if a deviation occurs during zigzag line travel, depending on the floor to be cleaned and the performance of the product.

The effects of the present disclosure are not limited to the effects mentioned above, and other effects not mentioned will be clearly understood by those skilled in the art from the description of the claims.

### BRIEF DESCRIPTION OF THE DRAWING

FIG. 1 is a configuration diagram of a smart home system including a robot cleaner according to an embodiment of the present disclosure.

FIG. 2 is a perspective view of a robot cleaner according to an embodiment of the present disclosure.

FIG. 3 is a bottom view of the robot cleaner according to an embodiment of the present disclosure.

FIG. 4 is another state diagram of the bottom view of the robot cleaner according to an embodiment of the present disclosure.

FIG. 5 is a block diagram showing a controller and components related to the controller, in a robot cleaner according to an embodiment of the present disclosure.

FIGS. 6A to 7C are views illustrating a rotation of rotary mops when a robot cleaner moves according to an embodiment of the present disclosure.

FIG. 7 is a flowchart showing an overall operation of the robot cleaner system in FIG. 1 according to the present disclosure.

FIGS. 8A to 8B illustrate normal zigzag travel of the robot cleaner in FIG. 7.

FIG. 9 illustrates an estimation of a deviation position from the zigzag in FIG. 7.

FIG. 10 shows a calculation of the distance when the normal zigzag travel of FIG. 7 is maintained.

FIG. 11 shows a calculation of the zigzag distance relative to the deviation position of FIG. 7.

FIGS. 12A to 12C illustrate a change in zigzag distance.

FIG. 13 illustrates the provision of modes of a robot cleaner on a user terminal.

FIGS. 14A to 14C illustrate the modes of the robot cleaner of FIG. 13.

### BEST MODE FOR CARRYING OUT THE INVENTION

Expressions referring to directions such as “front(F)/rear(R)/left(Le)/right(Ri)/up(U)/down(D)” mentioned below are defined as indicated in the drawings. However, the expressions are only to explain the present disclosure so that the present disclosure can be clearly understood, and the directions may be differently defined depending on a criterion.

Use of terms “first and second” in front of components mentioned below is only to avoid confusion of the referred component, and is independent of an order, importance, or master/slave relationship between the components. For example, an invention including only a second component without a first component can be implemented.

In the drawings, a thickness or a size of each component is exaggerated, omitted, or schematically illustrated for convenience and clarity of the explanation. The size and area of each component do not entirely reflect the actual size or area.

Moreover, an angle and a direction mentioned in describing a structure of the present disclosure are based on those described in the drawings. In description of a structure in the specification, if a reference point and a positional relationship with respect to the angle are not explicitly mentioned, reference is made to the related drawings.

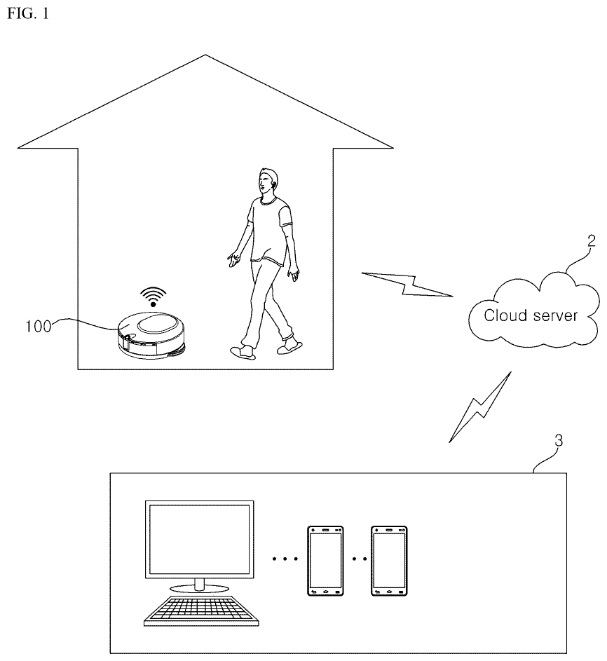

FIG. 1 is a configuration diagram of an artificial intelligence robot system according to an embodiment of the present disclosure.

Referring to FIG. 1, the robot system according to the embodiment of the present disclosure may have one or more robot cleaners 100 and provide a service at a prescribed place such as a house. For example, the robot system may include a robot cleaner 100 that provides a cleaning service at a specified place in a home. In particular, such a robot cleaner 100 may provide a dry, wet, or dry/wet cleaning service corresponding to a functional block included in it.

Preferably, a robot system according to an embodiment of the present disclosure may include a plurality of artificial intelligence robot cleaners 100 and a server 2 capable of managing and controlling the plurality of artificial intelligence robot cleaners 100.

The server 2 may remotely monitor and control the state of the plurality of robot cleaners 100, and the robot system is able to provide a more effective service by using the plurality of robot cleaners 100.

The plurality of robot cleaners 100 and the server 2 may have a communication means (not shown) that supports one or more communication protocols and communicate with each other. Also, the plurality of robot cleaners 100 and the server 2 may communicate with a PC, a mobile terminal, and other external servers 2.

For example, the plurality of robot cleaners 100 and the server 2 may be implemented to communicate wirelessly by wireless technologies such as IEEE 802.11 WLAN, IEEE 802.15 WPAN, UWB, Wi-FI, Zigbee, Z-wave, and Blue-Tooth. The robot cleaners 100 may differ depending on the communication method of the server 2 or other devices they intend to communicate with.

In particular, the plurality of robot cleaners 100 may implement wireless communication with other robots 100 and/or the server 2 over a 5G network. By wireless communication over a 5G network, the robot cleaners 100 are capable of real time response and real time control.

A user may see information on the robots 100 within the robot system through a user terminal 3 such as a PC, a mobile terminal, etc.

The server 2 may be implemented as a cloud server 2, and the cloud server 2 may interwork with the robots 100 to monitor and control the robot cleaners 100 and remotely provide a variety of solutions and content.

The server 2 may store and manage information received from the robot cleaners 100 and other devices. The server 2 may be a server 2 provided by the manufacturer of the robot cleaners 100 or a company the manufacturer is outsourcing its service to. The server 2 may be a control server 2 that manages and controls the robot cleaners 100.

The server 2 may control the robot cleaners 100 collectively in the same way or control the robot cleaners 100 individually. Meanwhile, the server 2 may be configured as a plurality of servers across which information and functions are distributed, or may be configured as a single integrated server.

The robot cleaners 100 and the server 2 may communicate with each other by having a communication means (not shown) that supports one or more communication protocols.

The robot cleaners 100 may transmit data related to spaces, objects, and usage to the server 2.

As used herein, the data related to spaces, objects, and usage may be recognition-related data on spaces and objects recognized by the robot cleaners 100 or image data on spaces and objects acquired by an image acquisition unit.

In some embodiments, the robot cleaners 100 and the server 2 may include a software- or hardware-based artificial neural network (ANN) that is programmed to recognize at least one of a user, a speech, a property of a space, and a property of an object such as an obstacle.

According to an embodiment of the present disclosure, the robot cleaner 100 and the server 2 may include a deep neural network (DNN), such as CNN (Convolutional Neural Network), RNN (Recurrent Neural Network), and DBN (Deep Belief Network), that is trained by deep learning. For example, a controller 140 of the robot cleaners 100 may have a deep neural network (DNN) architecture such as CNN (Convolutional Neural Network).

The server 2 may train the deep neural network (DNN) based on data received from the robot cleaners 100 and data inputted by the user, and then transmit updated deep neural network (DNN) architecture data to the robots 1. Accordingly, the deep neural network (DNN) architecture with artificial intelligence provided in the robots 100 may be updated.

Moreover, the usage-related data is data acquired from the use of the robot cleaners 100, which may correspond to usage history data, a sensing signal acquired by a sensor unit, etc.

The trained deep neural network (DNN) architecture may receive input data for recognition, recognize properties of a person, object, or space included in the input data and produce the results.

Moreover, the trained deep neural network (DNN) architecture may receive input data for recognition, analyze and learn data related to the usage of the robot cleaners 100, and recognize a usage pattern, a usage environment, etc.

Meanwhile, the data related to spaces, objects, and usage may be transmitted to the server 2 through a communication unit.

The server 2 may train the deep neural network (DNN) based on received data and then transmit updated deep neural network (DNN) architecture data to the artificial intelligence robot cleaners 100 to allow them to do updates.

Accordingly, the robots 100 will become smarter and smarter and provide user experience (UX) that will evolve with use.

Meanwhile, the server 2 may provide a user terminal with information about the control and current state of a robot cleaner 100, and may create and distribute an application for controlling the robot cleaner 100.

Such an application may be an application for use on a PC employed as the user terminal 3 or an application for use on a smartphone.

For example, it may be an application for controlling a smart home appliance, such as a SmartThinQ application, which is an application that can simultaneously control, manage, and supervise various electronic products of the present applicant.

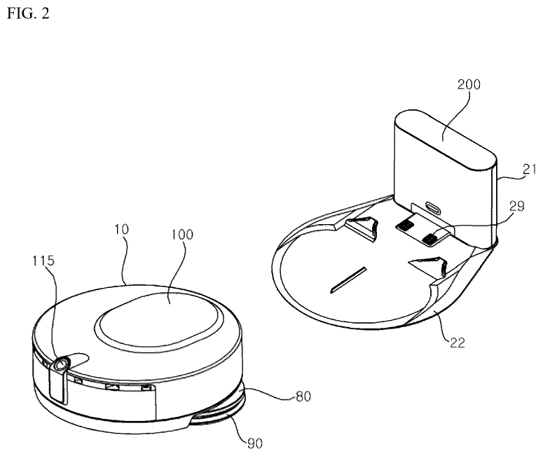

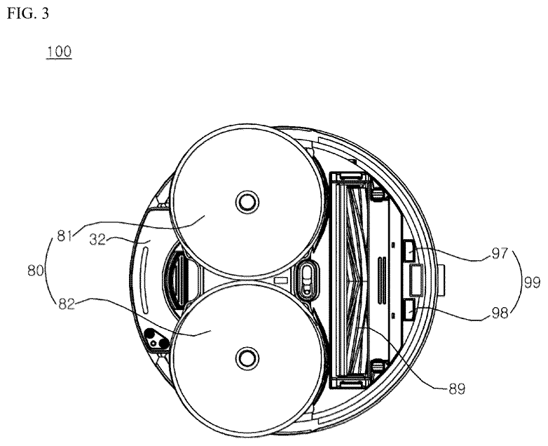

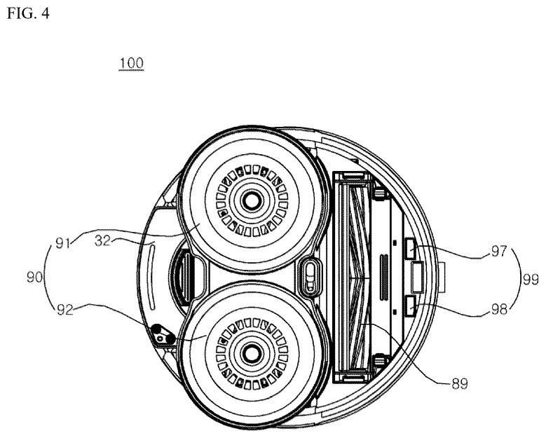

FIG. 2 is a perspective view of a robot cleaner according to an embodiment of the present disclosure. FIG. 3 is a bottom view of the robot cleaner according to an embodiment of the present disclosure. FIG. 4 is another state diagram of the bottom view of the robot cleaner according to an embodiment of the present disclosure.

Referring to FIGS. 2 to 4, a configuration of the robot cleaner 100 which makes a motion by the rotation of a rotary mop according to the present embodiment will be described briefly.

The robot cleaner 100 according to an embodiment of the present disclosure moves within an area and removes foreign matter on the floor during traveling.

In addition, the robot cleaner 100 stores the charging power supplied from a charging station 200 in a battery (not shown) and travels the area.

The robot cleaner 100 includes a main body 10 performing a designated operation, an obstacle detecting unit (not shown) which is disposed at the front surface of the main body 10 and detects an obstacle, and an image acquisition unit 115 photographing a 360-degree image. The main body 10 includes a casing (not shown) which forms an outer shape and forms a space in which components constituting the main body 10 are accommodated, a rotary mop 80 which is rotatably provided, a roller 89 which assists movement of the main body 10 and cleaning, and a charging terminal 99 to which charging power is supplied from the charging station 2.

The rotary mop 80 is disposed in the casing and formed toward the floor surface and a cleaning cloth is configured to be attachable and detachable.

The rotary mop 80 includes a first rotating plate 81 and a second rotating plate 82 to allow the main body 10 to move along the floor of the area by rotation.

When the rotary mop 80 used in the robot cleaner 100 of this embodiment rotates, a slip may occur that causes the robot cleaner 100 to not move as much as the rotary mop actually rotates. The rotary mop 80 may include a rolling mop driven by a rotation axis parallel to the floor or a spin mop driven by a rotation axis nearly perpendicular to the floor.

In the case where the rotary mop 80 includes a spin mop, the output current value of a drive motor that rotates the spin mop may vary with water content, which is the quantity of water contained in the spin mop, and if the water content is 0, this means that the spin mop contains no water at all. The water content according to this embodiment may be set as the ratio of the weight of water to the weight of a cleaning cloth. The spin mop may contain the same weight of water as the cleaning cloth or contain more water than the weight of the cleaning cloth.

The more water the rotary mop 80 contains, the more frictional force it generates against the floor surface because of the water as the water content becomes higher, thereby reducing the speed of rotation.

Decreasing the rotation speed of the drive motor 38 means that the torque of the drive motor 38 is increased, and accordingly, the output current of the drive motor 38 that rotates the spin mop is increased.

That is, a relationship is established in which, as the water content increases, the output current of the drive motor 38 that rotates the spin mop increases due to the increased frictional force.

In addition, the controller 150 can transmit various information by varying the output current of the drive motor 38 for a predetermined time. This will be described later.

The robot cleaner 100 according to the present embodiment may further include a water tank 32 which is disposed inside the main body 10 and stores water, a pump 34 for supplying water stored in the water tank 32 to the rotary mop 80, and a connection hose for forming a connection flow path connecting the pump 34 and the water tank 32 or connecting the pump 34 and the rotary mop 80.

The robot cleaner 100 according to the present embodiment includes a pair of rotary mops 80 and moves by rotating the pair of rotary mops 80.

The main body 10 travels forward, backward, left, and right as the first rotating plate 81 and second rotating plate 82 of the rotary mop 80 rotate about a rotating axis. In addition, as the first and second rotating plates 81 and 82 rotate, the main body 10 performs wet cleaning as foreign matter on the floor surface is removed by the attached cleaning cloth.

The main body 10 may include a driving unit (not shown) for driving the first rotating plate 81 and the second rotating plate 82. The driving unit may include at least one drive motor 38.

A control panel including a manipulation unit (not shown) that receives various commands for controlling the robot cleaner 100 from a user may be provided on the upper surface of the main body 10.

In addition, the image acquisition unit 115 is disposed on the front or upper surface of the main body 10.

The image acquisition unit 115 captures an image of an indoor area. On the basis of the image captured by the image acquisition unit 115, it is possible to detect obstacles around the main body as well as to monitor the indoor area.

The image acquisition unit 115 may be disposed forwardly and upwardly at a certain angle to capture images in front of or above the mobile robot. The image acquisition unit 115 may further include a separate camera for capturing images in front. The image acquisition unit 115 may be disposed above the main body 10 to face a ceiling, and in some cases, a plurality of cameras may be provided. In addition, the image acquisition unit 115 may be provided with a separate camera for photographing the floor surface.

The robot cleaner 100 may further include a position obtaining means (not shown) for obtaining current position information. The robot cleaner 100 may include GPS and UWB to determine the current position. In addition, the robot cleaner 100 may determine the current position by using an image.

The main body 10 includes a rechargeable battery (not shown), and a charging terminal 99 of the battery may be connected to a commercial power source (e.g., a power outlet in a home) or the main body 10 may be docked to the charging station 200 connected to the commercial power source, so that the charging terminal may be electrically connected to the commercial power source through contact with a terminal 29 of the charging station and the battery may be charged by the charging power supplied to the main body 10.

The electric components constituting the robot cleaner 100 may be supplied with power from the battery, and thus, once the battery is charged, the robot cleaner 100 may autonomously move while electrically separated from the commercial power source.

Hereinafter, a description will be made on the assumption that the robot cleaner 100 is a wet cleaning mobile robot. However, the robot cleaner 100 is not limited thereto, and it should be noted that any robot that detects sound while autonomously traveling an area can be applicable.

FIG. 4 is a diagram illustrating an embodiment in which a cleaning cloth is attached to the mobile robot of FIG. 2.

As shown in FIG. 4, the rotary mop 80 includes a first rotating plate 81 and a second rotating plate 82.

Cleaning cloths 90 (91, 92) may be attached to the first rotating plate 81 and the second rotating plate 82, respectively.

The rotary mop 80 is configured such that a cleaning cloth is attachable to and detachable from it. The rotary mop 80 may have a mounting member for attachment of the cleaning cloth 90 (91, 92) provided at the first rotating plate 81 and the second rotating plate 82, respectively. For example, the rotary mop 80 may be provided with a Velcro, a fitting member, or the like so that the cleaning cloth is attached and fixed. In addition, the rotary mop 80 may further include a cleaning cloth frame (not shown) as a separate auxiliary means for fixing the cleaning cloth to the first rotating plate 81 and the second rotating plate 82.

The cleaning cloth 90 absorbs water to remove foreign matter through friction with the floor surface. The cleaning cloth 90 is preferably a material such as cotton fabric or cotton blend, but any material containing water in a certain ratio or higher and having a certain density can be used, and the material is not limited.

The cleaning cloth 90 is formed in a circular shape.

The shape of the cleaning cloth 90 is not limited to what is shown in the drawing and may be formed in a quadrangle, polygon, or the like. However, given the rotational motion of the first and second rotating plates 81 and 82, it is preferable that the first and second rotating plates 81 are configured in a shape that does not interfere with the rotation operation of the first and second rotating plates 81 and 82. In addition, the shape of the cleaning cloth 90 can be changed into a circular shape by the cleaning cloth frame which is provided separately.

The rotary mop 80 is configured such that, once the cleaning cloth 90 is mounted, the cleaning cloth 90 comes into contact with the floor surface. Given the thickness of the cleaning cloth 90, the rotary mop 80 is configured such that the distance between the casing and the first and second rotating plates 81 and 82 changes with the thickness of the cleaning cloth 90.

The rotary mop 80 may further include a member that adjusts the distance between the casing and the rotating plates 81 and 82 so that the cleaning cloth 90 and the floor surface come into contact, and generates a pressure on the first and second rotating plates 81 and 82 toward the floor surface.

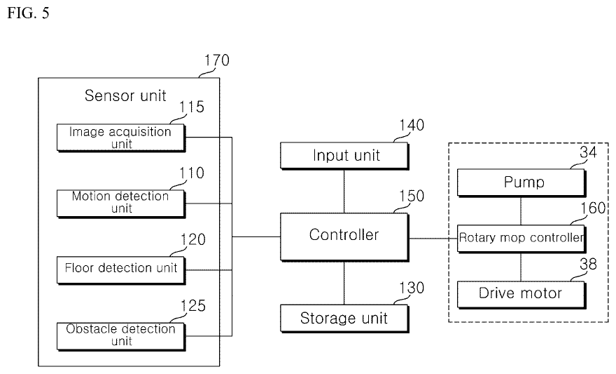

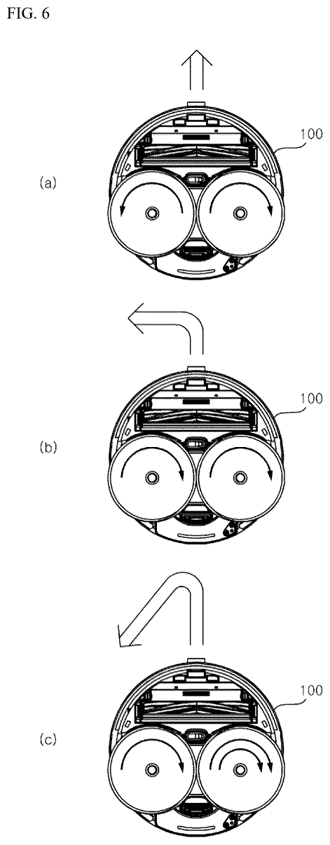

FIG. 5 is a block diagram showing a controller and components related to the controller, in a robot cleaner according to an embodiment of the present disclosure. FIGS. 6A to 6C are views illustrating a rotation of rotary mops when a robot cleaner moves according to an embodiment of the present disclosure.

As shown in FIG. 5, the robot cleaner 100 according to this embodiment includes a sensor unit 170 including the image acquisition unit 115 described previously.

The image acquisition unit 115 captures an image of an indoor area. On the basis of the image captured by the image acquisition unit 115, it is possible to detect obstacles around the main body as well as to monitor the indoor area.

Moreover, the sensor unit 170 further includes a motion detection unit 110 that detects a motion of the robot cleaner 100 according to a reference motion of the main body 10 when the rotary mop 80 rotates. The motion detection unit 110 may further include a gyro sensor detecting the rotational speed of the robot 10 or an acceleration sensor detecting an acceleration value of the robot cleaner 100. In addition, the motion detection unit 110 may use an encoder (not shown) that detects the moving distance of the robot cleaner 100.

The robot cleaner 100 may further include a floor detection unit 120 including a cliff sensor that detects the presence of a cliff on the floor in the cleaning area. The cliff sensor according to the present embodiment may be disposed at a front portion of the robot cleaner 100. In addition, the cliff sensor according to the present embodiment may be disposed on one side of a bumper.

If the cliff sensor is included, the controller 150 may identify the material of the floor based on the amount of reflected light received from the light receiving element as light emitted from the light emitting element is reflected off the floor, but is not limited thereto.

In addition, the sensor unit 170 may further include an obstacle detection unit 125. The obstacle detection unit 125 may detect the distance to an obstacle placed ahead, the shape of the obstacle, etc. and transmit a sensing signal to the controller 150 so as to control traveling.

The robot cleaner 100 according to the present embodiment further includes a rotary mop controller 160 that provides power to the drive motor 38 which rotates and controls the rotary mop 80, reads the output current of the drive motor 38, and transmits it to the controller 150.

The rotary mop controller 160 may be formed of a separate chip in which a simple logic is implemented, and may be disposed in a rotary mop module including the drive motor 38, a nozzle, and a pump 34.

The rotary mop controller 160 transmits a current for rotating the drive motor 38 according to a start signal from the controller 150 and reads the output current of the drive motor 38 according to a set period and transmits it to the controller 150.

These user settings may be stored in a storage unit 130 but are not limited thereto.

The controller 150 may alert the user's attention by alarming the user terminal 3 or the like about such a control result.

Meanwhile, the robot cleaner 100 according to the present embodiment may further include an input unit 140 for inputting a user's command. The user may set the method of driving the robot cleaner 100 or the operation of the rotary mop 80 through the input unit 140.

In addition, the robot cleaner 100 may further include a communication unit, and may provide the server 2 or the user terminal 3 with an alarm or information according to a determination result from the controller 150 through the communication unit.

FIG. 6 is a view illustrating a motion of the robot cleaner 100 according to an embodiment of the present disclosure. Referring to FIG. 6, a description will be given of how the robot cleaner 100 travels as the rotary mops rotates, and how the robot cleaner 100 moves.

The robot cleaner 100 according to the present embodiment includes a pair of rotary mops and rotates and moves by rotating the pair of rotary mops. The robot cleaner 100 may control the travelling of the robot cleaner 100 by varying the rotational direction or rotational speed of each of the pair of rotary mop. Accordingly, pattern traveling is possible through such control.

Referring to FIG. 6A, the robot cleaner 100 may move straight as each of the pair of rotary mops 80 rotates in opposite directions. In this case, the rotational speed of each of the pair of rotary mops is the same, but the rotational direction is different. The robot cleaner 100 may move forward or backward by changing the rotational directions of both of the rotary mops.

Moreover, referring to FIGS. 6B and 6C, the robot cleaner 100 may move rotationally as the pair of rotary mops rotate in the same directions. The robot cleaner 100 may rotate in place by varying the rotational speed of each of the pair of rotary mops, or may perform a round rotation moving in a curve. By varying the ratio of the rotational speeds of the pair of rotary mops of the robot cleaner 100, the radius of the round rotation can be adjusted.

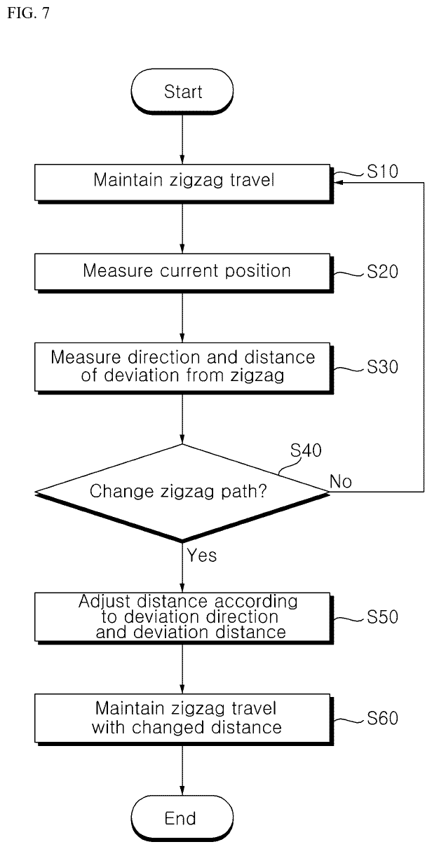

Hereinafter, a method of controlling the robot cleaner according to the present embodiment will be described with reference to FIGS. 7 to 12.

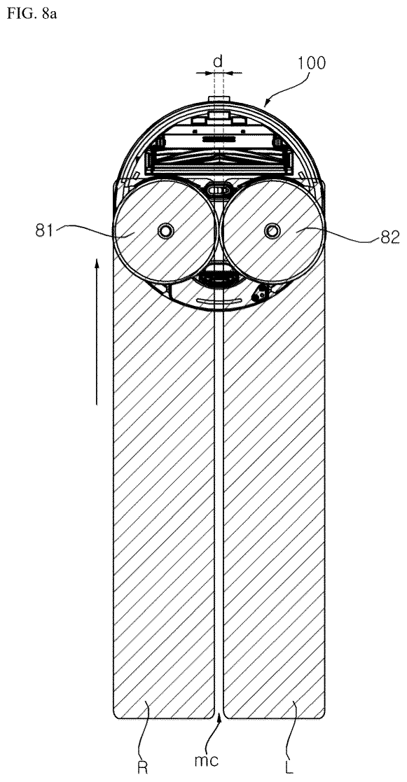

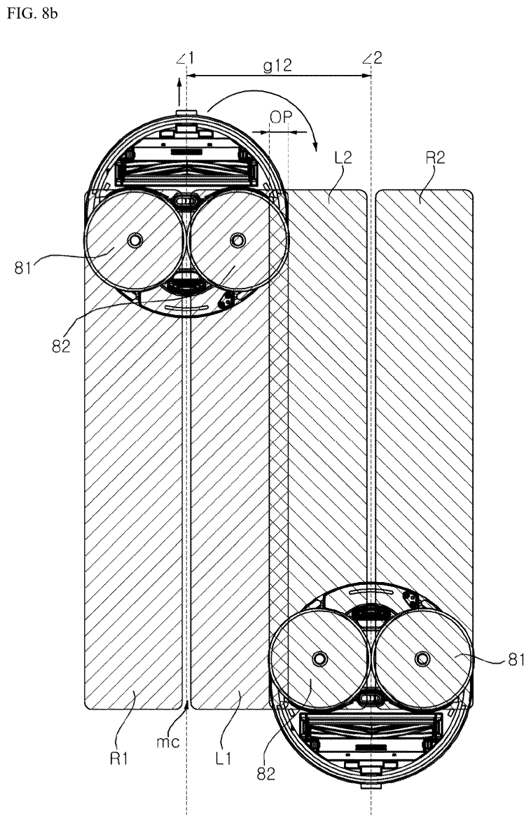

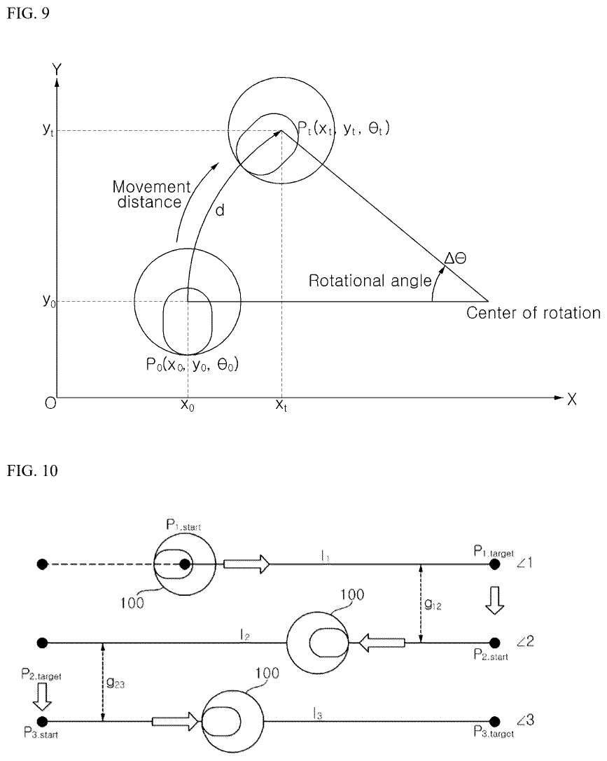

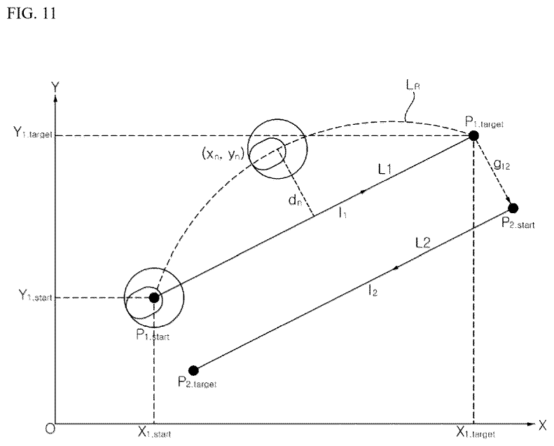

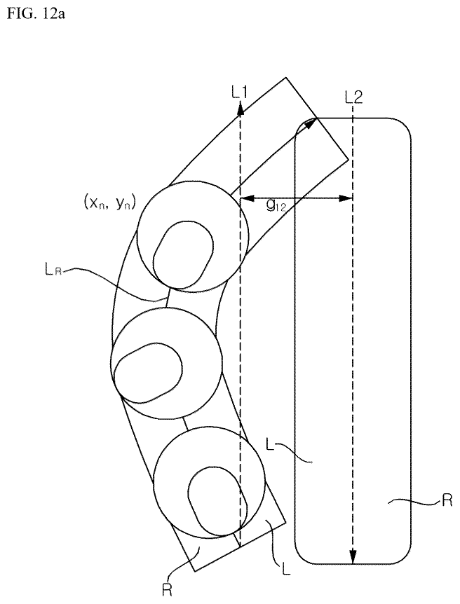

FIG. 7 is a flowchart showing an overall operation of the robot cleaner system in FIG. 1 according to the present disclosure. FIGS. 8A to 9B illustrate normal zigzag travel of the robot cleaner in FIG. 7. FIG. 9 illustrates an estimation of a deviation position from the zigzag in FIG. 7. FIG. 10 shows a calculation of the distance when the normal zigzag travel of FIG. 7 is maintained. FIG. 11 shows a calculation of the zigzag distance relative to the deviation position of FIG. 7.

Referring to FIG. 7, the robot cleaner 100 according to the present disclosure may travel in a zigzag pattern once it starts traveling (S10).

As for the zigzag travel, the robot cleaner 100 is known to eliminate an uncleaned area most effectively when it travels in a zigzag pattern. However, the robot cleaner 100 which is driven by the rotary mops 80 leaves an area uncleaned at the center of the main body 10, and therefore zigzag pattern travel cannot be used in the conventional manner.

Referring to FIG. 8A, the robot cleaner 100 using the rotary mops 80 may inevitably have an uncleaned area me caused by the rotary mops 80.

Referring to FIG. 8A, when the robot cleaner 100 cleans and moves as the rotary mops 80 rotate, the first rotary mop 81 on the right side and the second rotary mop 82 on the left side make their way touching the floor.

In this case, there may be an uncleaned area me having a predetermined width d between the movement trajectory L of the second rotary mop 82 on the left side and the movement trajectory R of the first rotary mop 81 on the right side.

If the second rotary mop 82 on the left side and the first rotary mop 81 on the right side, which are independent rotating bodies, are designed to touch each other, this may cause interference between them. Thus, a design with a margin is required to avoid interference.

Accordingly, a marginal region may be formed between the second rotary mop 82 and the first rotary mop 81 on the right side, and such a marginal region may cause an uncleaned area (mc) which is not cleaned even when the robot cleaner travels in a straight line.

Moreover, in order to travel with the rotary mops 81 and 82, the rotary mops 81 and 82 may be disposed slantingly. In this case, there may be an uncleaned area me at the center where the frictional force is relatively small.

In addition, uncleaned areas mc resulting from straight traveling may occur repeatedly in a zigzag pattern travel involving reciprocation of straight traveling.

Accordingly, in order to improve cleaning performance, a traveling method for a mopping robot cleaner is required that prevents the occurrence of an uncleaned area (mc) while maintaining the conventional intuitive traveling motion.

FIG. 8B is a view referred to in the description of a method for controlling the traveling of a robot cleaner 100 according to an embodiment of the present disclosure, that prevents the occurrence of an uncleaned area.

Referring to FIG. 8B, the controller 160 may control the robot cleaner 100 to travel in a zigzag pattern including first traveling ml involving traveling straight in a first direction and second traveling m2 involving traveling straight in a second direction opposite to the first direction.

In this case, the controller 150 may perform control such that zigzag travel is performed after setting the return direction in such a way that the zigzag distance covers an uncleaned area.

That is, the controller 150 may perform control such that there is an overlapping region between the movement trajectory L2 of the second rotary mop 82 on the left side or the movement trajectory R2 of the first rotary mop 81 on the right side, during the second traveling m2, and the movement trajectory L1 of the second rotary mop 82 on the left side or the movement trajectory R1 of the first rotary mop 81 on the right side, during the first traveling ml.

The controller 150 may control traveling such that there is an overlapping region between the movement trajectory of any one of the pair of rotary mops 81 and 82 and the movement trajectories L1 and Ri of the pair of rotary mops 81 and 82 during the previous straight traveling, depending on the direction of rotation for returning in a zigzag pattern.

FIG. 8B illustrates first traveling ml in an upward direction and second traveling m2 in a downward direction while rotating to the right or after rotating to the right. In this case, the controller 150 may control traveling such that there is an overlapping region op between the movement trajectory L2 of the second rotary mop 82 on the left side during the second traveling m2 and the movement trajectory L1 of the second rotary mop 82 during the previous straight traveling ml.

Such overlap control by the controller 150 may be performed by controlling the distance g12 between a first travel axis for the first traveling ml and a second travel axis L2 for the second traveling m2.

That is, the overlapping region op becomes larger as the distance g12 is decreased, and the overlapping region op becomes smaller as the distance g12 is increased.

The controller 150 properly controls this distance g12 depending on the situation, thereby allowing for zigzag travel in such a way as to prevent the occurrence of an uncleaned area.

That is, the controller 150 periodically measures the current position, determines whether the current position deviates from a corresponding travel axis in an n-th travel which is the current travel, and adjusts the distance g12 in real time so as to prevent the occurrence of an uncleaned area.

First, the controller 150 periodically measures the current position of the robot cleaner 100.

The current position of the robot cleaner 100 can be indicated by positional coordinates.

As shown in FIG. 9, when indicating the position of the robot cleaner 100 in a two-dimensional coordinate plane having an x-axis and a y-axis, the initial position of the robot cleaner 100 may be set to P₀(x₀, y₀, θ₀) which is indicated as the x-axis, the y-axis, and the angle.

After time t from the initial position, the position of the robot cleaner 100 may be indicated as Pₜ(xₜ, yₜ, θₜ).

In this case, the distance between the initial position P₀(x₀, y₀, θ₀) and the current position (the position after time t) Pₜ(xₜ, yₜ, θₜ) can be defined as the movement distance d.

The movement distance d can be measured in various ways.

For example, the movement distance d of the robot cleaner 100 from the image acquisition unit 115 may be measured, the rotational angle Δθ may be measured through a gyro sensor, and then, from this, the current position Pₜ from the initial position P₀ may be estimated.

That is, the estimated current position Pt is given by the following Equation 1:

$${x}_{t} = {x}_{0} + d \cdot cos {θ}_{t} , {y}_{t} = {y}_{0} + d \cdot sin {θ}_{t} , {θ}_{t} = {θ}_{0} + Δθ \qquad [ Mathematical Formula 1 ]$$

In this case, a feature point such as a ceiling is acquired from the image acquisition unit 115, and the movement distance d can be calculated from a change between the feature point on the previous image and the feature point at the current location.

Alternatively, contrariwise, in a case where an auxiliary wheel is disposed at the bottom of the robot cleaner 100, the speed of wheel may be measured through an encoder (not shown), whereby the current position Pt can be estimated from the initial position P₀.

In this way, the current position is periodically measured, and based on this, a zigzag travel path is created.

That is, as shown in FIG. 10, a point P_{1,target} is selected which is separated from the current position P_{1,start} by a distance of l₁, a first travel axis l₁ joining the two points P_{1,target} and P_{1,start} is created, and the starting position of a second travel axis L2 parallel to the first travel axis L1 is selected which is separated from P_{1,start} by a first distance g12 for the second travel axis L2 which is the next travel axis.

Once a point P_{2,target} is selected which is separated from the starting position of the second travel axis L2 by a distance of l₂, and the second travel axis L2 joining the two points P_{2,target} and P_{2,start} is created, the first travel axis L1 and the second travel axis L2 may be set as a continuous travel axes for zigzag travel.

A zigzag travel path may be set for the robot cleaner while repeating this calculation, in which case the initially set distance g12 may be equally set as the first distance g12.

Accordingly, the first distance g12 between the first travel axis L1 and the second travel axis L2 and the second distance g23 between the second travel axis L2 and the third travel axis L3 may be set equal.

The robot cleaner 100 may perform cleaning while traveling along the zigzag travel path defined above.

In this case, it is determined whether it deviates from the zigzag travel path, while periodically calculating the current position as shown in FIG. 9 (S20).

The controller 150 periodically determines the current position Pn and measures the direction and distance of deviation of the current position Pn from the zigzag travel path (S30).

Specifically, referring to FIG. 11, with a zigzag travel path defined on a two-dimensional coordinate plane, the current position Pn (x, y) at the current time n is indicated between a first starting position P_{1,start} and a first target position P_{1,target} with respect to the first travel axis L1, as shown in FIG. 11.

The coordinate values of the first starting position P_{1,start} and the first target position P_{1,target} with respect to the first travel axis L1 and the equation of the first travel axis L1 are given by the following Mathematical Formula 2:

$${P}_{1. start} = ( \begin{matrix}{x}_{1. start} & {y}_{1. start} & {θ}_{1. start}\end{matrix} ) , \qquad [ Mathematical Formula 2 ]$$

$${P}_{1. target} = ( \begin{matrix}{x}_{1. target} & {y}_{1. target} & {θ}_{1. target}\end{matrix} )$$

$${X}_{1. target} = {x}_{1. start} + {I}_{1} \cdot cos {θ}_{1. target}$$

$${Y}_{1. target} = {y}_{1. start} + {I}_{1} \cdot sin {θ}_{1. target}$$

$${θ}_{1. target} = {θ}_{1. start ,}$$

$$L 1 : tan ( {θ}_{1. start} ) x - y - ( {x}_{1 . start} tan ( {θ}_{1 . start} ) - {y}_{1. start} 〉 = 0$$

In this case, if the current position Pn (x, y) exists on the defined first travel axis L1, the traveling continues along the first travel axis L1 without a path change.

On the other hand, if the current position Pn (x, y) deviates from the first travel axis L1, the direction of deviation of the robot cleaner 100 from the first travel axis L1 of the zigzag travel path can be detected as follows.

$$L 1 ( {x}_{m} {y}_{n} ) > 0 : Deviation in the opposite direction to the zigzag travel direction \qquad [ Mathematical Formula 3 ]$$

$$L 1 ( {x}_{m} {y}_{n} ) < 0 : Deviation in the zigzag travel direc$$

Also, the distance do of deviation of the current position Pn (x, y) with respect to the first travel axis L1 of the zigzag travel path satisfies the following mathematical formula:

$${d}_{n} = \frac{\vert L 1 ( {x}_{n} , {y}_{n} ) \vert}{\sqrt{{tan}^{2} ( {θ}_{1. start} ) + 1}} \qquad [ Mathematical Formula 4 ]$$

Once the controller 150 has calculated the direction and distance of deviation of the current position Pn (x, y) with respect to a travel axis, the controller 150 determines whether to change the distance g12 between the travel axes (S40).

That is, if the deviation distance dₙ is smaller than the width of an overlapping region caused by the traveling on the first travel axis L1 and the second travel axis L2 spaced apart by the current distance g12, the controller 150 may perform traveling while maintaining the current distance g12 without changing the distance g12.

On the other hand, if the distance do of deviation of the current position Pn_(xy, y) is larger than the width of the overlapping region, the controller 150 periodically measures the distance and direction of deviation of the current position Pn (x, y) while traveling along the travel axes.

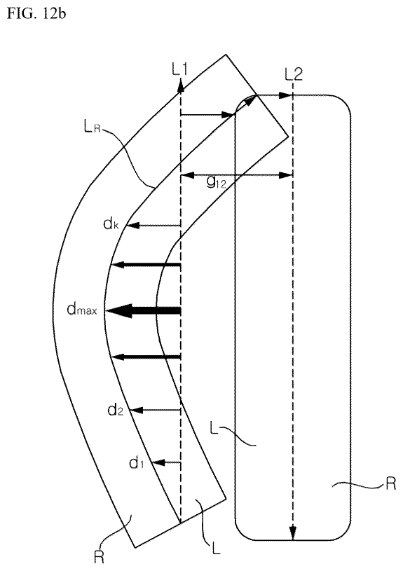

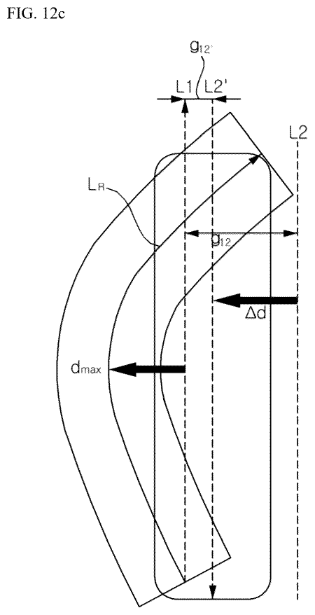

Specifically, as shown in FIG. 12A, if the robot cleaner 100 traveling in a zigzag along the first ravel axis L1 deviates from the first travel axis L1 depending on the situation on the floor or the water content, a difference is generated between the actual trajectory LR and the first travel axis L1.

In this instance, the current position Pn (x, y) is periodically calculated, and from the moment the distance do of deviation of the current position Pn (x, y) becomes larger than the width of the overlapping region, the distance do and direction of deviation relative to the position of the robot cleaner 100 is periodically calculated. In this case, the calculation can be made at more frequent intervals from the moment the distance do of deviation of the current position Pn (x, y) becomes larger than the width of the overlapping region, and the intervals can be set.

Accordingly, as shown in FIG. 12B, the distance do of deviation relative to the position of the robot cleaner 100 is calculated at intervals.

The controller 150 sets, as the maximum deviation distance dₘₐₓ, the maximum value of the distance do of deviation for each interval between the first travel axis L1 and the actual line when traveling along the first travel axis L1.

In this case, the maximum deviation distance dₘₐₓ is given by the following Mathematical Formula 5:

$${d}_{max} = max ( {d}_{n} ) , n = 1 , 2 , 3 , … , k \qquad [ Mathematical Formula 5 ]$$

In this case, L1 (xn, yn)>0 is satisfied.

For L1 (xn, yn)<0, the current distance g12 is maintained, and zigzag travel is performed.

The controller 150 changes the current distance from the preset first distance g12 to a corrected distance g12′. The corrected distance g12′ satisfies the following Mathematical Formula 6.

$${g}_{12}^{′} = First distance ( g 12 ) {g}_{12} - {d}_{max} = ( Width of robot cleaner - width of overlapping region ) - {d}_{max} \qquad [ Mathematical Formula 6 ]$$

In this way, the zigzag travel path can be changed for the corrected distance g12′ as shown in FIG. 12C (S60).

Accordingly, an uncleaned area that occurs during a first straight travel can be cleaned during a second straight travel, thereby preventing the occurrence of an uncleaned area.

Thus, it is possible to maintain zigzag travel after setting a zigzag travel path according to the corrected distance g12′.

Such an adaptive service for a zigzag travel path can be enabled or disabled according to the user's selection.

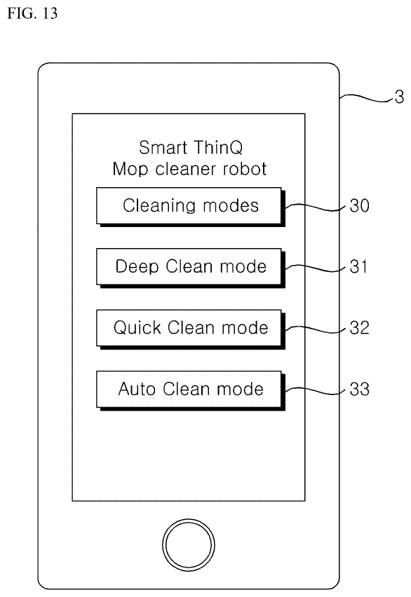

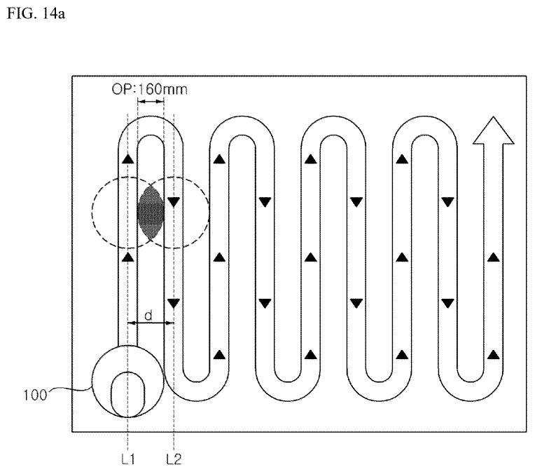

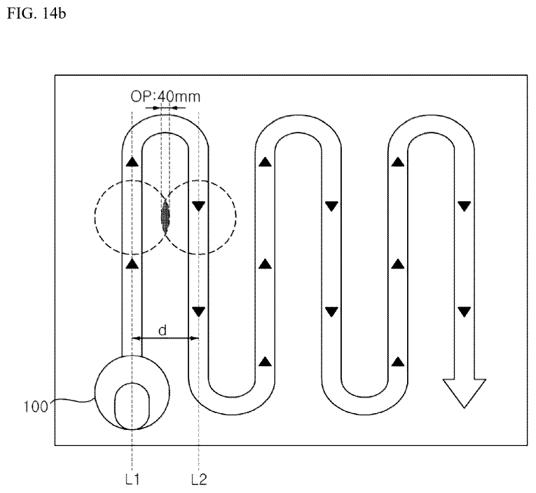

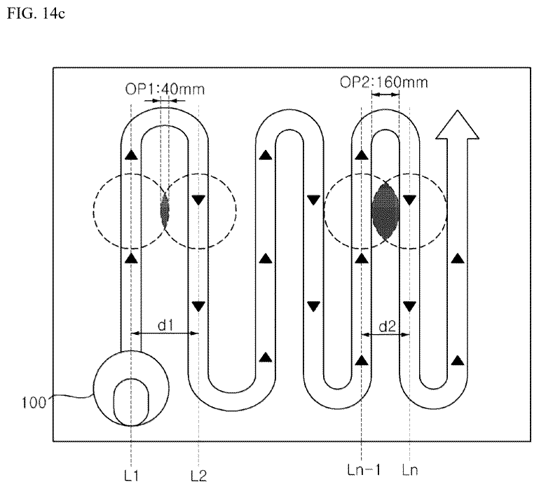

The provision of a cleaning mode according to an embodiment of the present disclosure will be described with reference to FIGS. 13 and 14.

FIG. 13 illustrates the provision of modes of a robot cleaner on a user terminal. FIGS. 14A to 14C illustrate the modes of the robot cleaner of FIG. 13.

In a robot cleaner system according to an embodiment of the present disclosure, a user application is downloaded online and installed on the user terminal 3.

The user application is run to sign up and register the robot cleaner 100 owned by the user on the application, and the robot cleaner 100 and the application are paired with each other.

The user terminal 3 may set up various functions for the robot cleaner 100. Specifically, it may configure settings for cleaning intervals, a cleaning mode, etc.

A cleaning mode 30 that can be configured on the user terminal 3 may be provided as three cleaning modes, for example, as shown in FIG. 13.

That is, three cleaning modes, referred to as Deep Clean mode 31, Quick Clean mode 32, and Auto Clean mode 33, may be provided on the user terminal 3.

Each of the cleaning modes 30 is illustrated in FIG. 13.

These cleaning modes 30 may be distinguished according to the size of the distance g12 and the movement speed of the robot cleaner 100. In Deep Clean mode 31 of FIG. 14A, the movement speed is slower than that of Quick Clean mode 32 and the distance g12 for the robot cleaner is quite small, which leads to a very wide overlapping region OP.

In Quick Clean mode 32 of FIG. 14B, the movement speed is slower than that of Deep Clean mode 31 and the distance g12 for the robot cleaner is quite large, which leads to a very small overlapping region OP. Accordingly, cleaning can be done very quickly, and cleaning can be completed much more quickly in a wide space with no obstacles.

On the other hand, Auto Clean mode 33 shown in FIG. 14C, an optimum travel trajectory is provided by automatically adjusting the distance g12 in real time depending on the condition of the floor and the traveling condition of the robot cleaner 100, as explained with reference to FIG. 7.

Accordingly, the distance g12 may be set differently for each travel axis L₁, L₂, . . . Lₙ₋₁, Lₙ.

If the user terminal 3 selects Auto Clean mode 33 from among these various cleaning modes 30, the entire traveled space can be cleaned without an uncleaned area by automatically adjusting the distance g12 as explained with reference to FIGS. 7 to 12.

In the above, exemplary embodiments of the present disclosure have been illustrated and described, but the present disclosure is not limited to the above-described specific embodiments, and the technical field to which the present disclosure pertains without departing from the gist of the present disclosure claimed in the claims. Of course, various modifications can be made by those skilled in the art, and these modifications should not be individually understood from the technical idea or prospect of the present disclosure.

[DESCRIPTION OF REFERENCE NUMERALS]

| | |
|---|---|
| 100: Robot cleaner | 10: Main body |
| 115: Image acquisition unit | 80: Rotary mop |
| 150: Controller | 110: Motion detection unit |
| 120: Floor detection unit | 130: Storage unit |
| 140: Input unit | 160: Rotary mop controller |

1. A robot cleaner comprising:
a main body for forming the exterior thereof;
a pair of rotary mops to which cleaning cloths are attached, and which come in contact with the floor and moves, while rotating, the main body in a zigzag pattern including first traveling, in which the main body travels straight in a first direction, and second traveling, in which the main body travels straight in a second direction that is opposite the first direction; and
a control unit for setting the zigzag pattern by varying the distance between a travel axis along which the main body travels during the first traveling and a travel axis during the second traveling according to the amount that the current position of the main body deviates from the travel axis.

2. The robot cleaner of 1, wherein the robot cleaner further comprises a sensor unit for periodically calculating the current position.

3. The robot cleaner of claim 1, wherein the controller calculates the distance and direction of deviation of the current position from the travel axis along which the main body travels.

4. The robot cleaner of claim 3, wherein, if the deviation direction is a positive direction, the controller corrects the distance according to the deviation distance and resets the next travel axis so as to have a corrected distance.

5. The robot cleaner of claim 4, wherein the controller sets the corrected distance for the next travel axis according to the maximum value of the distance of deviation during a straight travel on one of the travel axes.

6. The robot cleaner of claim 5, wherein the controller maintains the distance if the deviation direction has a negative value.

7. The robot cleaner of claim 1, wherein the controller performs control such that the first traveling and the second traveling are sequentially and repeatedly performed.

8. The robot cleaner of claim 1, wherein the controller sets the distance between the first traveling and the second traveling in such a way that the movement trajectories of the rotary mops have a predetermined overlapping region.

9. The robot cleaner of claim 8, wherein the controller sets the corrected distance in such a way that the difference between the width of the main body and the width of the overlapping region corresponds to a difference in the maximum value of the distance of deviation.

10. The robot cleaner of claim 9, wherein, if the maximum value of the distance of deviation is smaller than the width of the overlapping region, the controller maintains the distance.

11. A robot cleaner system comprising:
a robot cleaner for performing wet cleaning in a cleaning area;
a server that sends and receives information to and from the robot cleaner and performs control of the robot cleaner; and
a user terminal that is paired with the robot cleaner and the server and performs control of the robot cleaner as an application for controlling the robot cleaner is enabled,
the robot cleaner comprising:
a main body for forming the exterior thereof;
a pair of rotary mops to which cleaning cloths are attached, and which come in contact with the floor and moves, while rotating, the main body in a zigzag pattern including first traveling, in which the main body travels straight in a first direction, and second traveling, in which the main body travels straight in a second direction that is opposite the first direction; and
a control unit for setting the zigzag pattern by varying the distance between a travel axis along which the main body travels during the first traveling and a travel axis during the second traveling according to the amount that the current position of the main body deviates from the travel axis.

12. The robot cleaner system of 11, wherein the user terminal transmits a command value for a plurality of cleaning modes to the robot cleaner, and the controller sets a zigzag pattern by a distance that is set according to the command value.

13. The robot cleaner system of claim 12, wherein the controller calculates the distance and direction of deviation of the current position from the travel axis along which the main body travels.

14. The robot cleaner system of claim 13, wherein, if the deviation direction is a positive direction, the controller corrects the distance according to the deviation distance and resets the next travel axis so as to have a corrected distance.

15. The robot cleaner system of claim 14, wherein the controller sets the corrected distance for the next travel axis according to the maximum value of the distance of deviation during a straight travel on one of the travel axes.

16. The robot cleaner system of claim 15, wherein the controller maintains the distance if the deviation direction has a negative value.

17. The robot cleaner system of claim 11, wherein the controller performs control such that the first traveling and the second traveling are sequentially and repeatedly performed.

18. The robot cleaner system of claim 11, wherein the controller sets the distance between the first traveling and the second traveling in such a way that the movement trajectories of the rotary mops have a predetermined overlapping region.

19. The robot cleaner system of claim 18, wherein the controller sets the corrected distance in such a way that the difference between the width of the main body and the width of the overlapping region corresponds to a difference in the maximum value of the distance of deviation.

20. The robot cleaner of claim 19, wherein, if the maximum value of the distance of deviation is smaller than the width of the overlapping region, the controller maintains the distance.
